(19) United States
(12) Patent Application Publication
(10) Pub. No.: US 2009/0045717 A1
(43) Pub. Date: Feb. 19, 2009

(54) Lamp base

(75) Inventors: Albert M. Cavallaro, Durham, NH (US); George W. Mortimer, Park Forest, IL (US); Dennis S. Holt, Manchester, NH (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/893,662

(22) Filed: Aug. 17, 2007

(51) Int. Cl. H01J 5/48

(52) U.S. Cl. 313/318.01; 313/483; 439/226

(57) ABSTRACT

A special purpose lamp (12) (SPL) and a socket (14) therefore, the SPL (12) having a light source (16), a base (18) connected to the light source. The base (18) has electrical connectors (20) and a negative key (22). The socket (14) includes a pocket (23) for receiving the base (18), receptors (24) for receiving the electrical connectors (20) and a positive keyway (26) for receiving the negative key (22). In a preferred embodiment, the base (18) has a portion (18a) that is substantially rectangular in cross-section and the negative key (22) is associated with a corner (18b) of the portion (18a). Lamps so constructed can fit older sockets while older lamps will not fit the sockets of the invention.

### TECHNICAL FIELD

This invention relates to lamps and more particularly to lamp and socket combinations. Still more particularly, it relates to lamps having bases that allow use in more than one type of socket.

### BACKGROUND ART

Pin-based compact fluorescent lamps, among others, often employ a base that contains a key or other asymmetric configuration that allows the lamp to fit only into a specific socket. This ensures that a particular fixture will only be operated with lamp for which it was designed.

Occasionally, lamps are designed with the same electrical characteristics as existing lamps but with other differences that may require special adaptations in a socket. As one example, a new lamp may be designed to operate at much higher temperatures than an existing lamp, but still have the same electrical characteristics, such that the new lamp can be used in the same socket as the older version without causing any problems, whereas the opposite situation (the older version in the socket of the newer version) could create multiple problems.

It would be an advance in the art if a new lamp-socket combination could be provided that restricted access to the new socket by the older lamp, but still permitted the new lamp to be used with the older socket version.

### DISCLOSURE OF INVENTION

It is, therefore, an object of the invention to obviate the disadvantages of the prior art.

It is yet another object of the invention to enhance lamp operation.

These objects are accomplished, in one aspect of the invention, by the provision of a special purpose lamp (SPL) and a socket therefore, the SPL comprising: a light source, a base connected to the light source, the base having electrical connectors and a negative key; and the socket including a pocket for receiving the base and receptors for receiving the electrical connectors and a positive keyway for receiving the negative key.

By providing the base of the SPL with a negative key; that is, a key that involves the elimination or removal of material, a lamp is provided that that will fit not only its specific socket but older versions of existing sockets, where use of the SPL will not cause problems.

### BRIEF DESCRIPTION OF THE DRAWINGS

FIG. 1 is a perspective view of a lamp base for a SPL according to an aspect of the invention;

FIG. 2 is a plan view of a socket formed to accept the SPL; and

FIG. 3 is a plan view of an existing socket, which also will receive the SPL.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

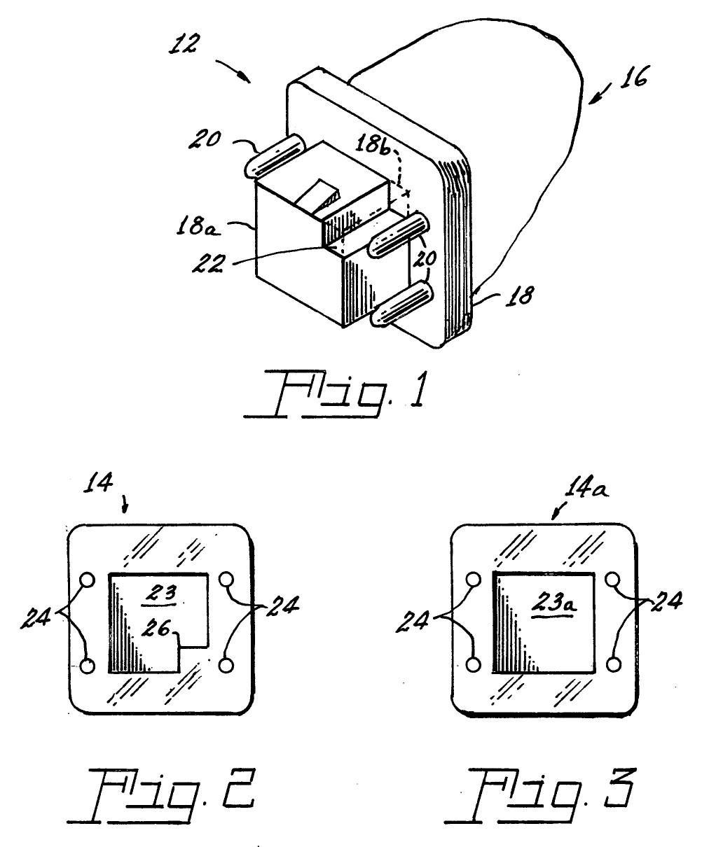

Referring now to the drawings with greater particularity, there is shown in FIG. 1 a special purpose lamp 12 (SPL) comprising: a light source 16, with a base 18 connected to said light source. The base has electrical connectors 20, which can be in the form of projecting pins, and a negative key 22. Preferably, the negative key 22 is formed in a portion 18a of the base 18 that is substantially rectangular in cross-section, and more specifically, the negative key 22 is formed in a corner 18b of the base 18. In the drawing, the corner 18b is shown in phantom lines since it has been removed to form the negative key 22.

The socket 14, shown in FIG. 2, includes a pocket 23 for receiving the base 18 as well as receptors 24 for receiving the electrical connectors 20 and a positive keyway 26 for receiving the negative key 22.

An older version of a socket, 14a, is shown in FIG. 3 as having a pocket 23a that does not have a positive keyway. Thus, the lamp 12 can be employed with either socket without causing any problems, whereas an older type lamp that was specifically designed to be used with the socket 14a, cannot be used with socket 14 and thus difficulties are avoided.

While the lamp and socket shown are specifically designed for “push-pull” operation, the features of the invention can be used with rotary types of lamps and sockets.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. In combination, a special purpose lamp (SPL) and a socket therefore, said SPL comprising:
a light source;
a base connected to said light source, said base having electrical connectors and a negative key; and
said socket including a pocket for receiving said base, receptors for receiving said electrical connectors and a positive keyway for receiving said negative key.

2. The combination of claim 1 wherein said base has a portion that is substantially rectangular in cross-section and said negative key is associated with a corner of said portion.
